(19) United States
(12) Patent Application Publication
(10) Pub. No.: US 2024/0329899 A1
(43) Pub. Date: Oct. 3, 2024

(54) IMAGE FORMING DEVICE AND IMAGE FORMING SYSTEM

(71) Applicant: BROTHER KOGYO KABUSHIKI KAISHA, Nagoya (JP)

(72) Inventor: Tetsuya OKUNO, Nagoya (JP)

(21) Appl. No.: 18/617,956

(22) Filed: Mar. 27, 2024

(30) Foreign Application Priority Data
Mar. 29, 2023 (JP) 2023-052664

(51) Int. Cl. G06F 3/12

(52) U.S. Cl. CPC G06F 3/1256; G06F 3/1259; G06F 3/1293

(57) ABSTRACT

An image forming device performs controlling an image forming engine to perform an image forming process within a processing amount, and transmitting an addition URL to a terminal device in response to a request from the terminal device. The processing amount decreases as the image forming process is performed. The addition URL corresponds to an addition web page to receive an addition operation to add an additional processing amount to the processing amount. The addition web page is a web page configured to receive the addition operation by being displayed on the terminal device. The image forming device controls the image forming engine to form images within an increased processing amount when the increasing operation is received through the addition web page displayed on the terminal device based on access to the addition URL.

### REFERENCE TO RELATED APPLICATIONS

This application claims priority from Japanese Patent Application No. 2023-052664 filed on Mar. 29, 2023. The entire content of the priority application is incorporated herein by reference.

### BACKGROUND ART

The present disclosure relates to technology of image forming equipment.

There is known an image forming system including a terminal device and an image forming device. An example of the image forming device is configured such that a parameter that decreases as an image forming process progresses is defined as a “processing amount,” and when the processing amount preset in the image forming device reaches a lower limit, the image forming process cannot be performed. In such an image forming system, when an application program in the terminal device is executed, the terminal device receives a user operation to add an additional processing amount to be processed by the image forming device, thereby enabling the image forming device to perform the image forming process within an increased processing amount including the additional processing amount.

### SUMMARY

In the known image forming system as described above, a user needs to download, in advance, a particular application program in the terminal device so that the terminal device could receive an instruction to add a certain additional amount to the processing amount.

According to an aspect of the present disclosure, an image forming device includes an image forming engine, and a controller. The controller is configured to perform controlling the image forming engine to perform an image forming process within a processing amount, and transmitting an addition URL in response to a request from a terminal device. The processing amount is to decrease as the image forming process is performed. The addition URL corresponds to an addition web page configured to receive an addition operation to add an additional processing amount to the processing amount. The addition web page is a web page configured to receive the addition operation by being displayed on the terminal device. The controller is configured to control the image forming engine to form images within an increased processing amount, which is a total of the processing amount and the additional processing amount, when the addition operation is received through the addition web page displayed on the terminal device based on access to the addition URL.

### BRIEF DESCRIPTION OF DRAWINGS

FIG. 1 shows a block diagram of an image forming system.

FIG. 2 shows a management table.

FIG. 3 is a sequence chart showing processes for purchasing additional printable pages.

FIG. 4 shows a property screen displayed on a terminal device.

FIG. 5 shows a login screen displayed on the terminal device.

FIG. 6 shows a web page of a registration site displayed on the terminal device.

FIG. 7 shows a login screen displayed on the terminal device.

FIG. 8 is a sequence chart showing processes for purchasing additional printable pages.

FIG. 9 shows a sequence chart of processes for purchasing additional printable pages.

FIG. 10 shows an additional-pages purchase site displayed on the terminal device.

FIG. 11 shows the additional-pages purchase site displayed on the terminal device.

FIG. 12 shows a device selection screen displayed on the terminal device.

FIG. 13 shows a timing chart of processes for purchasing additional printable pages.

### DESCRIPTION

An image forming system according to aspects of the present disclosure will be described with reference to the drawings.

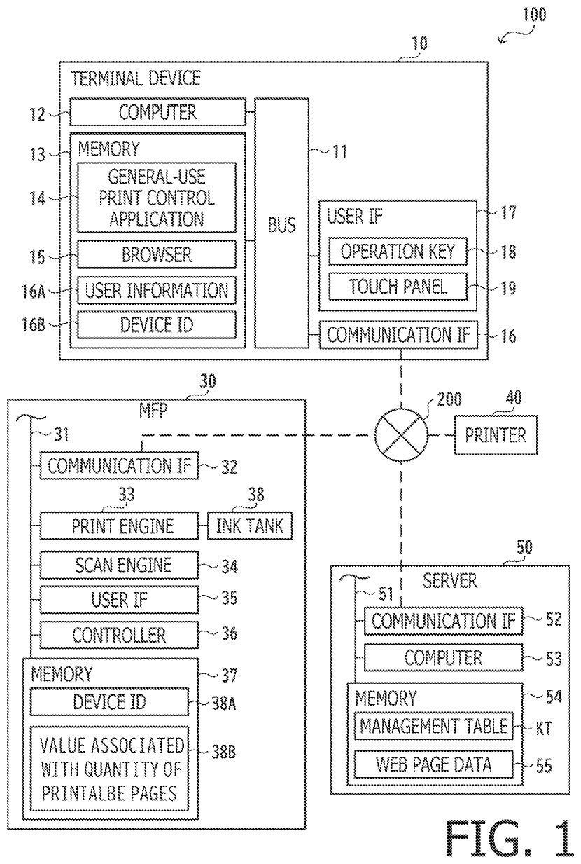

FIG. 1 is a block diagram showing an imaging system 100 including a terminal device 10, an MFP 30, a printer 40, and a server 50. The terminal device 10, MFP 30, and server 50 are connected to a network 200. It is noted that the MFP 30 is an example of an image processing device, and the printer 40 another example the image forming device. In this embodiment, the network 200 may be the Internet, a local area network (LAN), or a combination of a LAN and the Internet. The network 200 may be a wired network, a wireless network, or a combination of the wired and wireless networks.

The terminal device 10 may be a smartphone or a tablet terminal. The terminal device 10 has a bus 11, a computer 12, a memory 13, a user IF (“IF” being an abbreviation for “interface”) 17, and a communication IF 16. These components are communicatively connected to each other via the bus 11.

The user IF 17 has operation keys 18 and a touch panel 19. The touch panel 19 has a touch sensor that detects touching operations by a user and outputs signals according to a detection result by the touch sensor. The expression “touch” in this embodiment includes all operations in which an input medium is brought into contact with a display screen of the touch panel 19. Bringing the input medium close to the touch panel 19 to a position where the distance between the input medium and the touch panel 19 is very short may also be included in the concept of “touch.” The input medium may be a user's finger, a touch pen, or the like.

The communication IF 16 connects the terminal device 10 with the network 200 in accordance with a particular communication protocol. For example, the communication IF 16 is capable of performing Wi-Fi (registered trademark of Wi-Fi Alliance) wireless communication based on the IEEE 802.11 standard and equivalent standards. The communication IF 16 may also perform short-range wireless communication such as Bluetooth (registered trademark of Bluetooth SIG, Inc. USA) with the MFP 30. The communication IF 16 may perform wireless communication using a mobile communication system via a base station.

The memory 13 stores user information 16A, device ID 16B, an OS (an operating system), a general-use print control application 14, and a browser 15. Hereafter, an application is also described simply as “app.” The computer that executes these programs may also be described simply by the program names. For example, the statement “the general-use print control application 14” may mean “the computer 12 executing the general-use print control application 14.” The same applies to the MFP 30 and the server 50. The user information 16A is information for uniquely identifying a user of the terminal device 10, specifically, the general-use print control application 14. The device ID 16B is information for uniquely identifying the MFP 30.

The computer 12 is configured to cause the MFP 30 and the printer 40 to execute a printing process by executing the general-use print control application 14 when the OS is running. The general-use print control application 14 is a program that has functions to generate standard data for printing based on a particular printing standard and to transmit the generated standard data to the MFP 30 and the printer 40. The general-use print control application 14 is a standard program provided by the OS to realize the printing process. The standard data transmitted by the general-use print control application 14 is non-rasterized data but data compliant with a standard suitable for a general-use rasterization process. Since the general-use print control application 14 is a general-purpose program that is compatible with various printing devices that support a particular printing standard, any imaging device equipped with functions compatible with this general-use print control application 14 can perform printing based on the standard data. Because the general-use print control application 14 is a general-purpose program that supports multiple models, the print settings that can be accepted are limited to general ones. Therefore, the general-use print control application 14 does not necessarily accept all print settings that can be executed on the MFP 30. For example, “AirPrint” (registered trademark of Apple Inc.) and “Mopria” (registered trademark of Mopria Alliance) are systems for printing using the general-use print control application 14.

The browser 15 is a program configured to obtain web page data via the network 200 and use the web page data to display a web page on the user IF 17. Hereinafter, a screen that the browser 15 displays on the user IF 17 after analyzing the web page data is referred to as a web page. The web page is not necessarily limited to a single page, but may include multiple pages. A set of multiple web pages with the same domain is also described as a site. For example, a site for purchasing additional printable pages (hereinafter referred to as an additional-pages purchase site) described below is a site including multiple web pages.

In this embodiment, processing of a computer according to instructions described in a program is mainly described. That is, “determining,” “selecting,” “calculating,” “identifying,” “obtaining,” “receiving,” “controlling,” or other processes in the following description represent processing by a computer or a controller processing. Processing by the computer includes hardware control via an OS. It is noted that “obtaining” is used as a concept that does not require a request. That is, a receiving process of data without a request by each program is also included in the concept of “obtaining data.” Further, “data” in this specification is expressed in a computer-readable format. Data that has the same substantive content but a different format is treated as the same data. The same applies to “information” in this specification.

Next, the MFP 30 will be described. Description of a configuration of the printer 40 is omitted since the configuration is similar to a configuration of the MFP 30. The MFP 30 includes a bus 31, a communication IF 32, a print engine 33, a scan engine 34, a user IF 35, a controller 36, and a memory 37. Each component included in the MFP 30 are communicatively connected via the bus 31. The MFP 30 further includes multiple ink tanks 38.

A configuration of the communication IF 32 is similar to that of the communication IF 16 of the terminal device 10. A configuration of the user IF 35 is similar to that of the user IF 17 in the terminal device 10, and the user IF 35 includes a touch panel, and operation keys which serve as physical keys.

The print engine 33 is configured to print an image on a recording medium such as a sheet or a disc. The print engine 33 is an inkjet-type unit that ejects ink as a recording medium onto the recording medium, and has a print head and a carriage that reciprocates the print head in a main scanning direction. The ink tank 38 is connected to the print engine 33 and supplies ink to the print head in the print engine 33. In this system, there are four types of ink (cyan, magenta, yellow, and black), and multiple ink tanks 38 are provided for each type of ink. When the ink in the ink tank 38 runs low, a user may order from the vendor a bottle containing ink to be injected into the ink tank 38. The MFP 30 may be configured such that replaceable cartridges are attached.

The scan engine 34 is configured to generate scan data by reading a document set on a document table or an ADF (abbreviation for Automatic Document Feeder) with a scanning sensor.

The controller 36 includes a CPU and an ASIC (abbreviation for Application Specific Integrated Circuit), and is configured to control operations of the print engine 33, the scan engine 34, and the user IF 35. The memory 37 stores various programs and data. The memory 37 may be a combination of a RAM, a ROM, and a flash memory. The memory 37 may also include a storage medium readable by the controller 36, which is a computer. The storage medium includes recording media such as a CD-ROM and a DVD-ROM.

The memory 37 stores a device ID 38A and a value 38B associated with a quantity of printable pages. The device ID 38A is information that identifies the MFP 30 and is the same information as the device ID stored in the memory 13 of the terminal device 10. The printable pages will be described below.

The controller 36 also functions as a web server that is connected to the network 200. The controller 36 functioning as the web server is configured to provide various types of data, including web page data, in response to a request from a client (i.e., the terminal device 10) via HTTP communication.

Next, the server 50 configured to provide a printing service according to this embodiment is described. The server 50 has a bus 51, a communication IF 52, a computer 53, and a memory 54, which are communicably connected via the bus 51. It is noted that the server 50 is not limited to be configured by a single device, but may further include a management server configured to manage multiple MFPs 30. Alternatively, the server 50 may be configured to function as a management server.

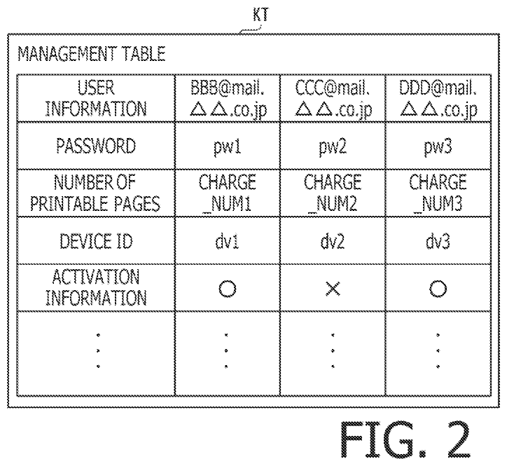

The memory 54 of the server 50 stores a management table KT (see FIG. 2) and web page data 55. The web page data configures the additional-pages purchase site described below. As shown in FIG. 2, the management table KT is configured to store information necessary for the server 50 to provide printing service. In the management table KT, as information related to users who use the printing service, user information and passwords are stored in an associated manner. In this embodiment, the user information represents e-mail addresses of respective users. In the management table KT, as information regarding a device, the number of printable pages, a device ID, activation information, and device settings are stored in association with the user information. The number of printable pages indicates the number of pages on which printing can be performed by the MFP 30 or the printer 40 with billing, and is information that indicates a value different from a remaining amount of the ink in the ink tank 38. The activation information indicates whether an initial configuration of the MFP 30 for the server 50 has been completed. When the activation information is set to an ON state (marked as “O” in FIG. 2), execution of printing by the MFP 30 is allowed. When the activation information is set to an OFF state (marked as “X” in FIG. 2), the execution of printing by the MFP 30 is restricted. In addition to this, in the management table KT, device settings indicating settings of respective functions (e.g., a paper size, color, magnification, and the like) for each device, and cumulative ink consumption indicating a cumulative amount of ink consumed by the MFP 30.

It is noted that the number of printable pages stored in the management table KT of the server 50 is initially set to a particular number which is granted by payment of an initial fee by the user. In the printing service, each time a printing process is performed by the MFP 30, the number of printable pages stored in the management table KT is decreased. When the number of printable pages reaches “0”, the MFP 30 will no longer be able to print even if the ink remains in the ink tank 38. If the user wishes to print more pages than the particular number allowed by the initial payment, the user can purchase additional printable pages by paying a certain charging fee to the server 50. Based on payment of the certain charging fee, the number of purchased pages are added to the number of printable pages. Concretely, the user can purchase additional printable pages at the additional-pages purchase site that is an external site managed by the server 50. When the user purchases additional printable pages at the additional-pages purchase site, the number of printable pages in the management table KT is increased and becomes greater than 0, thereby the MFP 30 can resume printing. In the present embodiment, the web page data configures the additional-pages purchase site, which is an example of an addition web page.

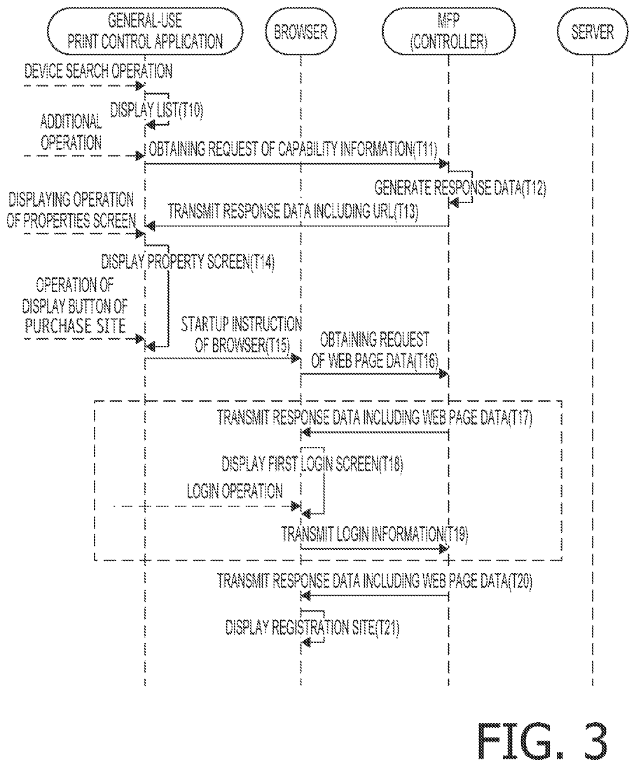

Next, processes when the user operates the terminal device 10 to access the additional-pages purchase site are described with reference to FIG. 3. At the time of executing the processes shown in FIG. 3, it is assumed that the MFP 30 is not registered as a device used for the printing service. The fact that the MFP 30 is unregistered as a device used in the printing service means that no information (e.g., the device ID and the user information) regarding the MFP 30 is stored in the management table KT that is managed by the server 50. In the following, a state where the MFP 30 is not registered as a device used in the printing service is also expressed simply as “the MFP 30 is not registered in the printing service.”

First, the user starts the general-use print control application 14 by operating the terminal device 10, and the general-use print control application 14 causes the user IF 17 to display a device selection screen. When accepting a device search operation, the general-use print control application 14 displays a list of devices that can be used in the printing process on the user IF 17 at T10 (hereinafter, “T” is used to represent “time” such that T10 means Time10, T11 means Time11, and the like).

It is now assumed that the user performs an adding operation, on the list display screen displayed on the user IF 17, to add the MFP 30 as a device to be used in the printing service.

When receiving the adding operation to add the MFP 30, the general-use print control application 14 requests capability information from the MFP 30 at T11. The capability information indicates, for example, a type of a function that the MFP 30 is capable of performing, or the type of service the MFP 30 is capable of providing. When, for example, the MFP 30 is compatible with the printing service, an item represented by the capability information includes information indicating that the MFP 30 is compatible with the printing service and whether or not the MFP 30 is registered for the printing service. In this embodiment, since the controller 36 of the MFP 30 functions as a web server, the general-use print control application 14 designates a URL “https//<mfp-ip-address>” indicating the address of the controller 36, and transmits thereto a request for the capability information.

When receiving the request for the capability information, the controller 36 of the MFP 30 retrieves the capability information stored in the memory 37 at T12 and generates response data including the retrieved capability information. The response data generated at T12 includes the URL of the web page that the browser 15 displays at T21 or T42 which will be described below. Concretely, the controller 36 determines whether the MFP 30 is registered for the printing service based on information contained in the capability information, and changes a URL to be included in the response data according to the result of the determination.

In detail, when the capability information includes information indicating that the MFP 30 is registered for the printing service, the controller 36 generates response data including a URL (i.e., “https://<AAA_site>/charge”) to display the additional-pages purchase site managed by the server 50. The URL indicating the additional-pages purchase site is also referred to as the “addition URL” in the following description. On the other hand, when the capability information does not include information indicating that the MFP 30 is registered for the printing service, the controller 36 generates response data including a URL (i.e., “https//<mfp-ip-address>/charge”) indicating the registration site managed by the controller 36. This URL indicates a registration web page for registering the MFP 30 as a device to be used for the printing service, and is also referred to as a “registration URL” in the following description. In this embodiment, the web described in detail below.

Since the MFP 30 is not registered for the printing service, the controller 36 generates response data including the device ID of the MFP 30, the capability information, and the registration URL at T12. At T13, the controller 36 transmits the response data including the registration URL to the terminal device 10. In this embodiment, the process performed by the controller 36 at T13 is an example of a transmitting process of an addition URL.

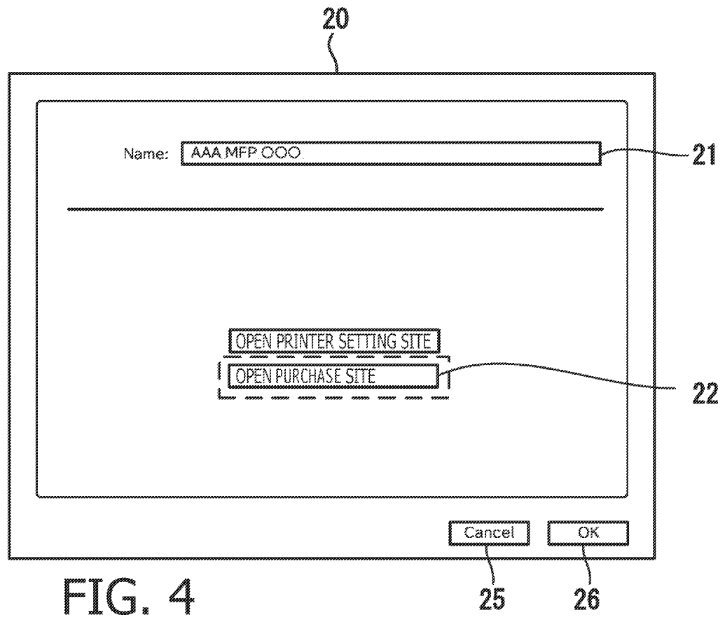

When receiving the response data, the general-use print control application 14 of the terminal device 10 displays a property screen 20 on the user IF 17 at T14 as shown in FIG. 4 using the capability information included in the response data. The property screen 20 is a screen displayed by the general-use print control application 14 using each value of the capability information, and is different from the web page displayed by the browser 15 described below.

As shown in FIG. 4, the property screen 20 includes a device selection field 21 and a purchase-site display button 22. The device selection field 21 is for receiving an operation to select a device to be used by the terminal device 10 in the printing process. In the device selection field 21, a list of selectable devices is displayed in a drop menu format according to the operation. In an example shown in FIG. 4, a device name “AAA_MFP_0000” of the MFP 30 of which the capability information was obtained by the process at T11 is shown in the device selection field 21. The purchase-site display button 22 is an icon that receives an operation that causes the terminal device 10 to access an additional-pages purchase site managed by the server 50 on the condition that the device selected in the device selection field 21 (in this example, the MFP 30) is registered for the printing service. The additional-pages purchase site is an example of an addition web page.

When the user operates the purchase-site display button 22 arranged on the property screen 20, the general-use print control application 14 gives a startup instruction to the browser 15 at T15. At this time, the general-use print control application 14 specifies the URL that has already been obtained from the MFP 30 (in this example, the URL for registration “https//<mfp-ip-address>/charge”) to the browser 15.

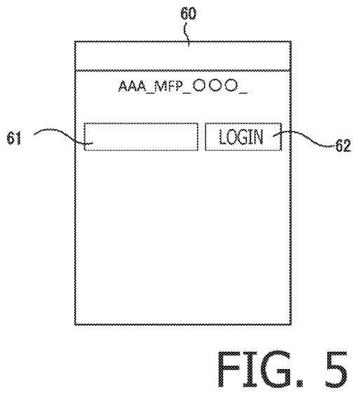

When receiving the startup instruction from the general-use print control application 14, at T16, the browser 15 requests the controller 36, which is a web server, for the web page data with designating a URL for registration. Upon receiving the request for the web page data from the browser 15, the controller 36 transmits response data including the web page data of a first login screen 60 shown in FIG. 5 to the browser 15 at T17, since no login has been performed to the MFP 30.

When receiving the response data including the web page data, at T18, the browser 15 analyzes the received web page data and displays the first login screen 60 on the user IF 17. When the user performs the login operation of entering a login password in an input field 61 of the first login screen 60 and operating a login button 62, the browser 15 transmits the entered login password to the controller 36 at T19. When receiving the login password, the controller 36 transmits the response data including the web page data of the registration site to the browser 15 at T20, on the condition that the authentication to this login password is successful.

When the login to the MFP 30 has already been completed, in response to receiving the request for the web page data at T16, the controller 36 transmits response data including the web page data of the registration site to the browser 15 at T20. That is, in this case, the processes related to the login for MFP 30 from T17 to T19 are not performed.

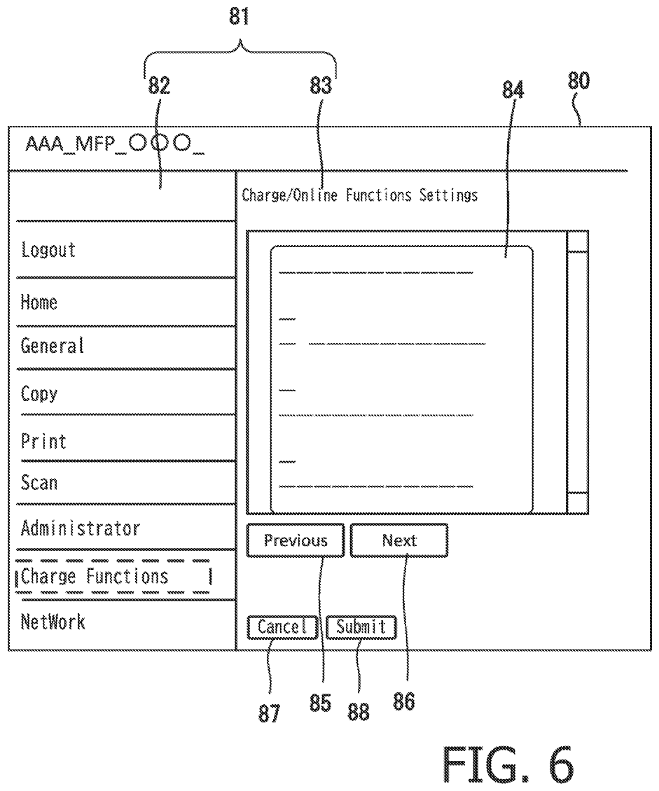

When receiving the response data including the web page data from the MFP 30, the browser 15 displays the web page 80 of the registration site shown in FIG. 6 on the user IF 17 at T21. The web page 80 shown in FIG. 6 includes a page display area 81 including an item column 82 and a content display column 83. The item column 82 is a part that receives a selection operation of various functions of the MFP 30. In this embodiment, the item column 82 includes buttons respectively corresponding to functions of the MFP 30. When any of the buttons in the item column 82 is operated, the browser 15 displays a screen in accordance with the function corresponding to the operated button in the content display column 83. In addition to the above configuration, the page display area 81 may also include a URL display area configured to display the URL of the registration site in an upper portion of the page display area 81.

In the web page 80 of the registration site, the content display column 83 includes text 84 that describes the terms and conditions for registering for the printing service. The user can scroll the display of the text 84 by operating a forward button 86 or a return button 85. By operating a cancel button 87, the user can, for example, cancel the contents displayed in the content display column 83 or the input to the web page 80.

When the user operates a submit button 88 for the web page 80 of the registration site, the browser 15 requests the MFP 30 to provide registration instructions at T22. When receiving the request for registration instructions from the browser 15, the controller 36 of the MFP 30 transmits a device ID of the MFP 30 (e.g., serial information of the MFP 30) to the server 50 at T23. When the server 50 receives the identification information from the MFP 30, the server 50 performs a registration process at T24 to register the received device ID in the management table KT shown in FIG. 2.

The controller 36 of the MFP 30 generates, at T25, web page data including an instruction to execute a redirection process, including the URL for addition (i.e., “https://<AAA_site>/charge”) stored in the memory 13 and the device ID of the MFP 30. The controller 36 of the MFP 30 generates response data including the web page data generated at T25 and transmits the response data to the browser 15 at T26.

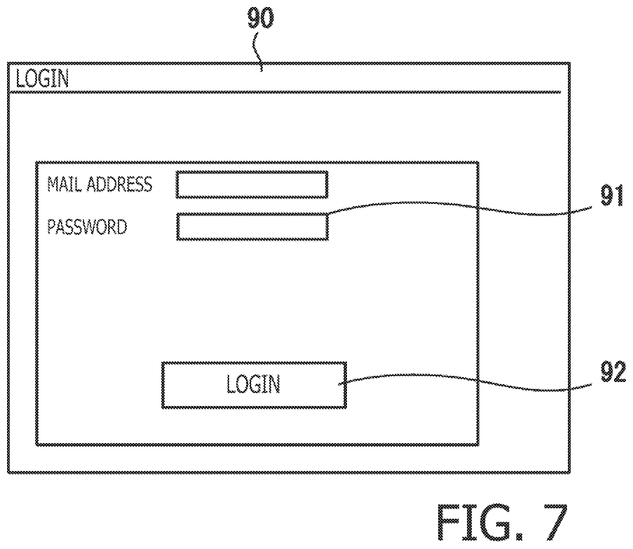

When displaying the web page data included in the response data from the MFP 30 at T27, the browser 15 of the terminal device 10 displays a second login screen 90 of the additional-pages purchase site, which is shown in FIG. 7, based on the instruction for executing the redirection process included in the web page data. The second login screen 90 is a screen for logging in to the additional-pages purchase site. It is assumed that, since the user has not completed the registration of the MFP 30 to the printing service, the user operates an icon (not shown in figures) on the second login screen 90 to register user information to the printing service. Specifically, the user enters the user information (i.e., the e-mail address) and the password, with respect to the displayed screen.

At T28, the browser 15 transmits the user information and the password as entered to the server 50. At T29, the server 50 registers the user information and the password received from the MFP 30 in the management table KT in association with the device ID of the MFP 30 which has already been registered. As the registration of the MFP 30 to the management table KT has been completed, the activation information is changed from invalid “X” to valid “O”, which means that the MFP 30 has been registered as a device to be used for the printing service. The server 50 notifies the MFP 30 of information indicating that the MFP 30 has been registered for the printing service.

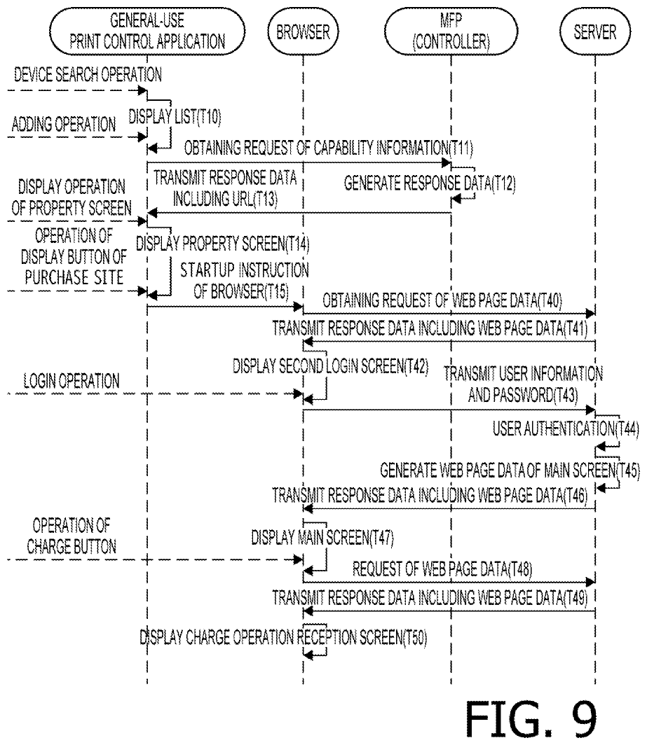

Next, the process when the user operates the terminal device 10 to purchase additional printable pages after the registration of the MFP 30 for the printing service will be explained with reference to FIG. 9. It is noted that the processes from T10 to T11 in FIG. 9 have already been described with referent to FIG. 3.

At T12, when receiving the request for the capability information from the terminal device 10, the controller 36 of the MFP 30 retrieves the capability information stored in the memory 37 and generates response data including a URL corresponding to the contents of the capability information. In this example, since the capability information includes information indicating that the MFP 30 is registered for the printing service, the controller 36 generates the addition URL (i.e., https://<AAA_site>/charge) which indicates the address of the additional-pages purchase site. Then, the controller 36 transmits the response data including the generated addition URL to the general-use print control application 14.

When receiving the response data, the general-use print control application 14 displays, at T14, the property screen 20 shown in FIG. 4 on the user IF 17 based on the capability information included in the response data. When the user operates the purchase-site display button 22 on the property screen 20, the general-use print control application 14 gives a startup instruction to the browser 15 at T15. At this time, the general-use print control application 14 designates the addition URL (i.e., https://<AAA_site>/charge), which has already been obtained from the MFP 30, to the browser 15.

When the browser 15 receives the startup instruction from the general-use print control application 14, the browser 15 requests the server 50 to obtain web page data by designating the addition URL (i.e., https://<AAA_site>/charge) at T40. That is, in this example, the browser 15 requests the web page data from the server 50, not from the controller 36 of the MFP 30. In addition, the browser 15 transmits the device ID of the MFP 30 to the server 50 with the request for the web page data at T40.

When the server 50 receives the request for the web page data and the device ID, the server 50 transmits the response data including the web page data designated by the addition URL to the browser 15 at T41. The server 50 first transmits the response data including the web page data to display the second login screen 90 shown in FIG. 7, which has already been explained, to the browser 15.

When receiving the response data, the browser 15 analyzes the received web page data and displays the second login screen 90 on the user IF 17 at T42. It is assumed that the user performs a login operation by entering the registered e-mail address and password in the input fields 91 of the second login screen 90, and then operating the login button 92. In that case, the browser 15 transmits the user information and password entered by the login operation to the server 50 at T43.

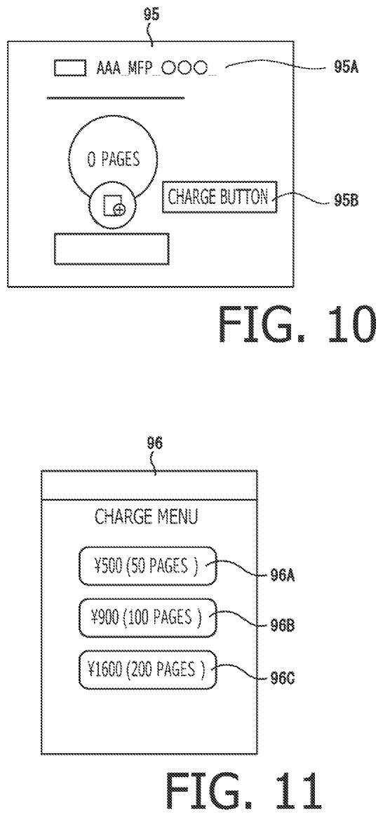

When receiving the user information and password from the MFP 30, the server 50 performs user authentication, at T44, using the entered user information and password. When the user authentication at T44 is successfully completed, the server 50 generates web page data corresponding to the main screen of the additional-pages purchase site shown in FIG. 10. Then, at T46, the server 50 transmits the response data including the generated web page data to the browser 15.

When receiving the response data, the browser 15 displays, at T47, a main screen 95 of the additional-pages purchase site shown in FIG. 10 on the user IF 17. On an upper part of the main screen 95, a device name 95A corresponding to the device ID of the MFP 30 is displayed. Accordingly, the user can identify which device (in this example, the MFP 30) the user is trying to purchase additional printable pages for.

When the user operates a charge button 95B included in the main screen 95, the browser 15 transmits a request for the web page data of the charge operation reception screen 96 shown in FIG. 11 to the server 50 at T48. When receiving the request for the web page data designating the URL, the server 50 transmits, at T49, the response data including the web page data of a charge operation reception screen 96 according to the designated URL to the browser 15. At T50, the browser 15 analyzes the received web page data to display the charge operation reception screen 96 on the user IF 17. The charge operation reception screen 96 includes icons 96A, 96B, and 96C for receiving an operation to designate an additional page set. Each of the icons 96A to 96C shows the number of additional printable pages to be purchased and a fee required to purchase the additional printable pages. In this example, the icon 96A is an icon to be operated when an additional set of “50” pages is purchased. The icon 96B is an icon to be operated when an additional set of “100” pages is purchased. The icon 96C is an icon to be operated when an additional set of “200” pages is purchased.

When the user selects one of the icons 96A-96C on the charge operation reception screen 96 displayed by the browser 15 and operates a confirm icon (not shown in figures), the browser 15 transmits the number of additional printable pages corresponding to the selected icon to the server 50. On the condition that a billing process is completed for the number of additional printable pages received by the server 50, the server 50 adds the number of purchased pages to the number of printable pages specified by the device ID in the management table KT. The server 50 transmits an instruction to the MFP 30 to add the number of purchased pages. When the MFP 30 receives the instruction to add the number of purchased pages received from the server 50, the MFP 30 adds the number of purchased pages to the number of printable pages stored in the memory 37. That is, the MFP 30 increases the total number of printable pages by adding the number of purchased pages. Thus, the user is able to print with using the MFP 30 within the number of printable pages to which the number of purchased pages has been added.

The above described embodiment achieves the following effects.

When the controller 36 of the MFP 30 receives an instruction from the terminal device 10 in response to the operation of the purchase-site display button 22, the controller 36 transmits the URL of the web page of the additional-pages purchase site, which is an external site, to the terminal device 10. When the operation to purchase additional printable pages is received on the additional-pages purchase site displayed by the terminal device 10, the controller 36 is configured to cause the print engine 33 to execute the printing processing within the number of printable pages after addition. With this configuration, since the user can display the additional-pages purchase site, which is an external site, on the terminal device 10 according to the URL transmitted from the MFP 30, the user can purchase additional printable pages without having to download an application for displaying the additional-pages purchase site to the terminal device 10 in advance.

The controller 36 of the MFP 30 transmits the URL of the registration site managed by the controller 36 to the terminal device 10 when the MFP 30 is not yet registered for the printing service. The controller 36 transmits the URL of the additional-pages purchase site managed by the server 50 to the terminal device 10 when the MFP 30 is already registered for the printing service. With this configuration, the user can purchase additional printable pages after ensuring that the MFP 30 is registered with the printing service, in a case where the MFP 30 is not yet registered with the printing service.

The controller 36 transmits the identification information of the MFP 30 to the terminal device 10 with the URL for displaying the additional-pages purchase site. Thus, the user of the terminal device 10 is able to reliably identify the MFP 30 to which the number of additional printable pages is to be added.

In the embodiment described above, when the capability information includes information indicating that the MFP 30 is registered for the printing service, the controller 36 generates response data including the URL of the additional-pages purchase site as the addition URL at T12. Alternatively, when the purchase of additional printable pages is performed by an application downloaded by the terminal device 10, the controller 36 may have the response data include the URL of a site for downloading the application for purchasing additional printable pages as the addition URL at T12.

In the embodiment described above, the communication IF 16 of the terminal device 10 and the communication IF 32 of the MFP 30 are network interfaces, and both the terminal device 10 and the MFP 30 are connected to the network 200. The terminal device 10 is connected to the network 200, but the MFP 30 may not be connected to the network 200. In this case, the communication IF 32 is a USB IF, and the MFP 30 is connected to the terminal device 10 via the USB IF. With this configuration, since the MFP 30 is not connected to the network 200, the terminal device 10 may directly access the server 50 via the network 200 to purchase additional printable pages, which may allow the additional printable pages to be added smoothly. Therefore, in this embodiment, even when the terminal device 10 and the MFP 30 communicate via the USB IF as a communication IF, the MFP 30 may transmit the addition URL to the terminal device 10 in response to a request from the terminal device 10 to display the additional-pages purchase site. In this case, the general-use print control application 14 may directly transmit the device ID, the user information, and the password to the server 50 at T22 when registering the MFP 30 for the printing service. When the server 50 receives the device ID, the user information, and the password from the terminal device 10, the server 50 executes the registration process.

In another embodiment according to aspects of the present disclosure, explanations will be given mainly for configurations that differ from the embodiment described above. In this embodiment, the same symbols are attached to the same parts as in the embodiment described above, and the explanation of the same parts will be omitted.

In this embodiment, it is assumed that the MFP 30 and the printer 40 are registered for the printing service. The processes from T10 to T15 in FIG. 9 have already been described. When the user operates the terminal device 10 to purchase additional printable pages, in response to a startup instruction from the general-use print control application 14, the browser 15 specifies the addition URL indicating the additional-pages purchase site and requests the web page from the server 50 at T40 of FIG. 9. In this example, it is assumed that the browser 15 does not transmit device IDs of the MFP 30 and the printer 40 to server 50 at T40.

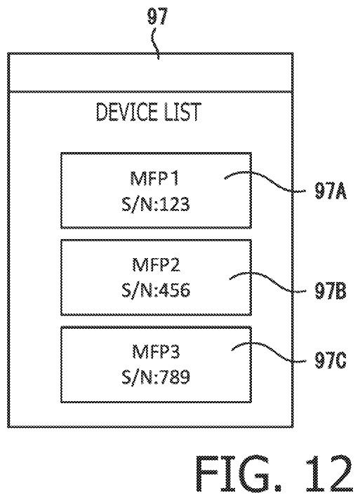

Since the controller 36 has not obtained the device ID from the browser 15 at T40, on the main screen 95 shown at T47, the device name 95A is not displayed at the upper part of the main screen 95, unlike the screen shown in FIG. 10. The user operates the charge button 95B included in the main screen 95 to cause the browser 15 to display the device selection screen 97 shown in FIG. 12 at T50. The processes at T48 and T49 have already been described above. The device selection screen 97 includes icons 97A, 97B, and 97C, which each receive an operation of selecting a device that can add the number of additional printable pages to the number of printable pages. The device corresponding to each icon 97A-97C is a device corresponding to the device ID associated with the user information on the management table KT. The user information used to identify the device ID is the user information entered on the second login screen 90.

When the user operates any of the icons 97A-97C, the browser 15 transmits an obtaining request for the web page data of the charge operation reception screen 96 shown in FIG. 11 to the server 50, along with the device ID identified by the selected icon among the icons 97A-97C. Thus, the server 50 is able to determine for which device additional printable pages will be purchased at the additional-pages purchase site. When the user selects and operates any of the icons 96A-96C on the charge operation reception screen 96 displayed by the browser 15 and operates a confirm icon (not shown in figures), the browser 15 transmits the number of additional printable pages corresponding to the selected icon to the server 50. On condition that the billing process is completed for the number of additional printable pages received by the browser 15, the browser 15 adds the number of purchased pages to the number of printable pages associated with the device ID identified by the operation of any of the icons 97A-97C on the device selection screen 97 in the management table KT.

In a further embodiment according to aspects of the present disclosure, explanations will be given mainly for configurations that differ from the embodiment firstly described above. In this embodiment, the same symbols are attached to the same parts as in the embodiment described above, and the explanation of the same parts will not be repeated.

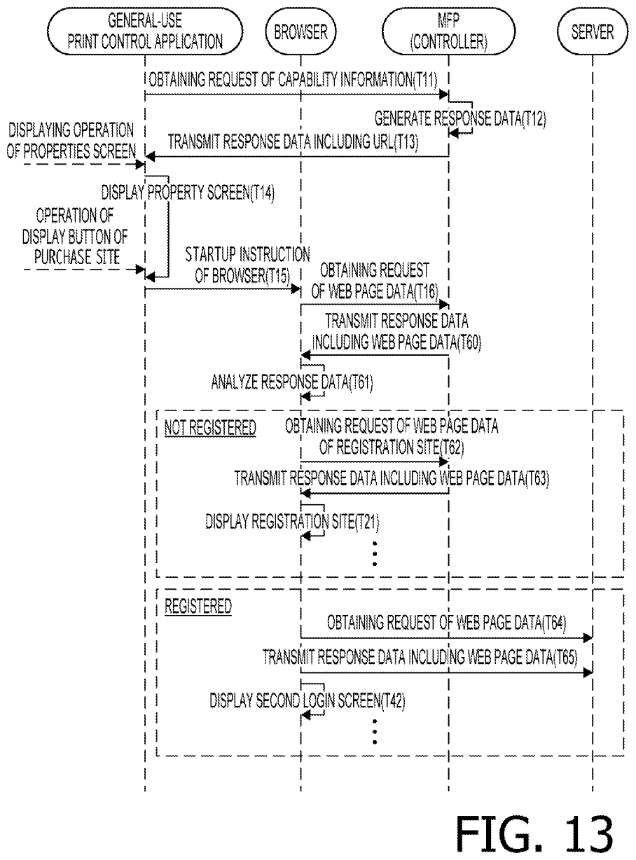

In this embodiment, unlike the first embodiment, the timing at which the controller 36 transmits the addition URL is different. At T12 in FIG. 13, the controller 36 of the MFP 30 generates the URL “https://<mfp_ip_address>/auto_redirect” regardless of whether the MFP 30 is registered or not. Specifically, at T12, the controller 36 generates the URL “https://<mfp_ip_address>”, which indicates the controller 36 as a web server, with the character string “auto_redirect” indicating that responding to the terminal device 10 with an instruction to execute the redirection process.

At T13, the controller 36 transmits response data including the capability information and the URL generated at T12 to the terminal device 10. When the general-use print control application 14 of the terminal device 10 receives the response data, at T14, it displays the property screen 20 shown in FIG. 4 on the user IF 17 using the capability information included in the response data. When the user operates the purchase-site display button 22, the general-use print control application 14 instructs to start the browser 15 at T15. At this time, the general-use print control application 14 instructs the browser 15 to use the URL “https://<mfp_ip_address>/auto_redirect” already obtained from the MFP 30.

When the browser 15 receives the startup instruction from the general-use print control application 14, the browser 15 specifies the URL “https://<mfp_ip_address>” of the controller 36 (i.e., a web server) among the URLs already obtained and requests the web page data from the controller 36 at T16. In this embodiment, it is assumed that login to the MFP 30 has been completed. If login to the MFP 30 has not been completed, the process from T17 to T19 shown in FIG. 3 is executed as in the first embodiment.

When the controller 36 of the MFP 30 receives the request to obtain the web page data, the controller 36 transmits response data including web page data of the top page indicated by the URL “https//<mfp-ip-address>” to the browser 15 at T60. When the browser 15 receives the response data, the browser 15 analyzes the response data (i.e., web page data) transmitted by the MFP 30 at T61. In this embodiment, the response data transmitted by the controller 36 to the terminal device 10 at T60 includes the addition URL “https://<AAA_site>/charge” and the registration URL “https//<mfp-ip-address>/charge.” Furthermore, the response data includes a script program to change the URL to be redirected to the browser 15, depending on whether the MFP 30 is registered for the printing service.

Specifically, the script program causes the browser 15 to redirect to the registration URL “https///<mfp-ip-address>/charge” indicating the registration site shown in FIG. 6 when the MFP 30 is not registered for the printing service. On the other hand, when the MFP 30 is registered for the printing service, the script program causes the browser 15 to execute a redirect to the URL “https://<AAA_site>/charge” corresponding to the additional-pages purchase site shown in FIG. 7.

In this example, the browser 15 executes the script program, and when the browser 15 determines that the MFP 30 is not registered for the printing service based on a value included in the capability information, the browser 15 requests web page data from the MFP 30 at T62 with specifying the registration URL. When the controller 36 of the MFP 30 receives the obtaining request for the web page data from the browser 15, the controller 36 transmits response data including the web page data of the registration site shown in FIG. 6 to the terminal device 10 at T63.

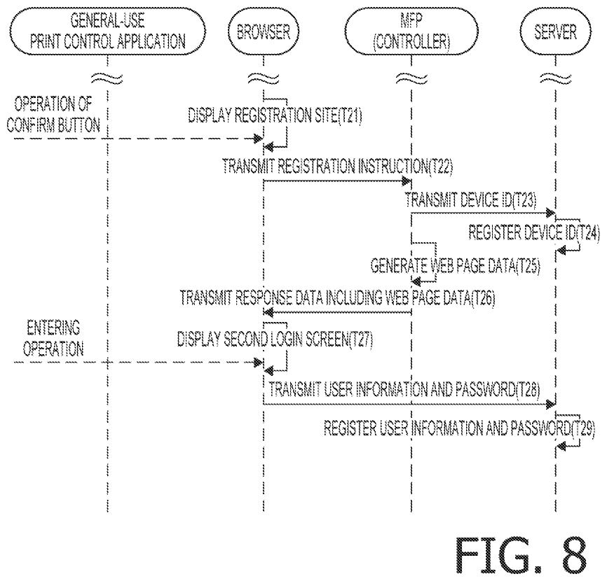

When the browser 15 receives the response data, at T21, the browser 15 displays the web page 80 of the registration site on the user IF 17. As already explained using FIG. 8, when the user operates the submit button 88 on the web page 80 of the registration site, the browser 15 requests registration instructions from the MFP 30 at T22. As already explained using FIG. 8, by executing the processes from T23 to T31, the device ID, user information, and password are registered in the management table KT of the server 50.

When the browser 15 executes the script program and determines that the MFP 30 is already registered for the printing service based on the value included in the capability information, at T64, the browser 15 specifies the URL “https://<AAA_site>/charge” of the additional-pages purchase site and request the web page data from the server 50. When the server 50 receives the request to obtain the web page data from the browser 15, the server 50 transmits response data including the web page data of the second login screen 90 shown in FIG. 7 to the terminal device 10 at T65.

When the browser 15 receives the response data from the server 50, the browser 15 displays the second login screen 90 on the user IF 17 at T42. As explained in FIG. 9, by the processes from T43 to T50, the charge operation reception screen 96 shown in FIG. 11 is displayed on the browser 15. In this embodiment, the process performed by the controller 36 at T60 is an example of the transmitting process. In this embodiment described above, the same effects as in the first embodiment can be achieved.

The technology disclosed herein is not limited to the embodiments described above, but can be transformed into various forms to the extent that it does not depart from the gist thereof, for example, the following transformations are possible.

In the embodiment described above, the controller 36 transmits the URL indicating the registration site to the terminal device 10 at T13 when the MFP 30 is not registered for the printing service. Alternatively, when the MFP 30 is not registered for the printing service, the controller 36 may generate a URL indicating a web page notifying that the MFP 30 is not registered for the printing service at T12, and transmits the URL to the terminal device 10 at T13. In this case, at T21, instead of displaying the web page 80 of the registration site, the browser 15 displays the web page notifying that the MFP 30 is not registered for the printing service.

In the embodiment described above, the imaging system 100 used the number of printable pages as the printable amount. Instead, an amount of usable ink, the ejection number of ink, or available sheet length may be used as the printable amount in the printing service. In addition to being used for the printing service with billing, the MFP 30 may also be used for the printing service without billing.

The print engine 33 included in the MFP 30 may be an electrophotographic unit that forms a toner image on a photoreceptor and transfers the formed toner image to a recording medium. In this case, a toner cartridge in which toner is stored is connected to the printing unit instead of the ink tank 38.

In the case where the image forming device is the MFP 30, processes performed by the processing unit may be a printing process as well as a scan process performed by the scan engine 34, or even a copy process performed jointly by the scan engine 34 and the print engine 33. In this case, the service may be a service that performs a scanning process in response to billing or a copying process in response to billing, and a processing amount may be the number of pages to be scanned or the number of pages to be copied.

In the above embodiment, a screen displayed based on the addition URL https://<AAA_site>/charge is the second login screen 90, and after transitioning through several pages, the charge operation reception screen 96 is displayed. Alternatively, the browser 15 may specify the addition URL, and the charge operation reception screen 96 may be displayed as it is.

What is claimed is:

1. An image forming device comprising:
an image forming engine; and
a controller;
wherein the controller is configured to perform:
controlling the image forming engine to perform an image forming process within a processing amount, the processing amount being to decrease as the image forming process is performed; and
transmitting an addition URL to a terminal device in response to a request from the terminal device, the addition URL corresponding to an addition web page configured to receive an addition operation to add an additional processing amount to the processing amount,
wherein the addition web page is a web page configured to receive the addition operation by being displayed on the terminal device, and
wherein the controller is configured to control the image forming engine to form images within an increased processing amount, which is a total of the processing amount and the additional processing amount, when the addition operation is received through the addition web page displayed on the terminal device based on access to the addition URL.

2. The image forming device according to claim 1,
wherein the controller is configured to work as a web server and transmit web page data to the terminal device in response to the request from the terminal device,
wherein the terminal device is configured to register the image forming device for a service related to the image forming process in response to an operation on a registration web page to be displayed based on the web page data to be transmitted from the web server, and
wherein the controller is configured to:
transmit a registration URL corresponding to the registration web page to the terminal device when the image forming device is not registered for the service; and
transmit the addition URL to the terminal device when the image forming device is registered for the service.

3. The image forming device according to claim 2,
wherein the addition URL is a URL corresponding to an external site other than a site of the web server.

4. The image forming device according to claim 2,
wherein the controller is configured to transmit a redirect URL to the terminal device to cause the terminal device to redirect to the addition URL in response to the request from the terminal device, and
wherein the terminal device is configured to specify the addition URL and obtain web page data of the addition web page in response to accessing the redirect URL when the image forming device is registered for the service.

5. The image forming device according to claim 1,
wherein the controller is configured to transmit identification information of the image forming device with the addition URL to the terminal device.

6. The image forming device according to claim 2,
wherein the controller is configured to:
determine whether the image forming device is registered for the service related to the image forming process;
transmit the registration URL to the terminal device in response to determining that the image forming device is not registered for the service; and
transmit the addition URL to the terminal device in response to determining that the image forming device is registered for the service.

7. The image forming device according to claim 1, further comprising a communication interface configured to connect the image forming device with a network,
wherein the terminal device is connectable with the network, and
wherein the image forming device and the terminal device are connected via the network.

8. The image forming device according to claim 1, further comprising a communication interface configured to communicate with the terminal device,
wherein the communication interface is a USB interface, and
wherein the terminal device is connectable with a network.

9. An image forming system comprising an image forming device and a terminal device,
wherein the image forming device includes:
an image forming engine; and
a controller,
wherein the controller is configured to perform:
controlling the image forming engine to perform an image forming process within a processing amount, the processing amount being to decrease as the image forming process is performed; and
transmitting an addition URL to the terminal device in response to a request from the terminal device, the addition URL corresponding to an addition web page configured to receive an addition operation to add an additional processing amount to the processing amount,
wherein the addition web page is a web page configured to be displayed on the terminal device and receive the operation, and
wherein the controller is configured to control the image forming engine to form images within an increased processing amount, which is a total of the processing amount and the additional processing amount, when the addition operation is received through the addition web page displayed on the terminal device based on access to the addition URL.
